(19) United States
(12) Patent Application Publication
(10) Pub. No.: US 2015/0313096 A1
(43) Pub. Date: Nov. 5, 2015

(54) Arrangement Comprising Tree Securing and Tree Securing Plate

(71) Applicant: H. Lorberg Baumschulerzeugnisse GmbH & Co. KG, Ketzin OT Tremmen (DE)

(72) Inventors: Jochen Brehm, Bestensee (DE); Stefan Heinrich Lorberg, Ketzin (DE)

(21) Appl. No.: 14/699,435

(22) Filed: Apr. 29, 2015

(30) Foreign Application Priority Data
Apr. 30, 2014 (EP) 14166727.9

(51) Int. Cl. A01G 23/04; A01G 7/06; A01G 17/04

(52) U.S. Cl. CPC A01G 23/04; A01G 17/04; A01G 7/06

(57) ABSTRACT

An arrangement is provided for tree securing. The arrangement includes: a tree, which encompasses a root ball, which is covered in a covering material, and a trunk comprising a tree crown on the end side, and a tree securing device, which is accommodated in the ground soil and which is equipped to secure an upright position of the planted tree, wherein the tree securing device is formed with a securing plate, which is arranged in the ground soil in horizontal position and so as to thus secure the tree against tilting out of the upright position. The securing plate includes anti-slip elements and/or bonding agents arranged on the cover surface side.

The invention relates to an arrangement comprising tree securing and a tree securing plate.

### BACKGROUND

Trees satisfy their required nutrient need by absorbing nutrients dissolved in ground water from the immediate ground soil environment of the root body. For this purpose, they form a plurality of fine roots, via which this nutrient flow flows. If this flow ceases, this would inevitably cause the tree to die. When newly planting trees comprising root balls, it is particularly important to provide a stable fixed support to the wood, in particular in the initial growing phase. Due to the slender trunk and the high crown, young trees have a tendency to swing. However, newly fanned fine roots are not to tear off.

To secure the upright position of young trees, above-ground tree securings are proposed. The most common form is the tripod, but one, two and four-legged supports are also used. In addition, securing devices in static or dynamic design are known. Guying, in the case of which tightened guy ropes are fastened to crotches of the tree on the one side and in the ground soil on the other side, is used hereby. In the case of the static design, guy ropes having a fixed length are used. A dynamic anchoring is formed, when the guy ropes yield at a defined length under stress.

In addition, below-ground tree securing devices have been proposed. These include root ball anchoring systems or underground anchoring, in the case of which disruptive piles and ropes are avoided as compared to the above-ground tree securing. In the case of a known tree securing device, provision is made for a wire guying on the root ball of the tree, which is installed when the tree is planted. Insofar as the tensioned wire ropes, which are used below-ground hereby, rest on the root ball, the latter can be protected from damage by means of mats, which are placed underneath the ropes. It has also been proposed as below-ground tree securing to use a double spike, in response to the use of which one spike half penetrates into the root ball from below and the other half is inserted into the ground soil underneath the root ball.

A tree securing device is provided in document DE 85 27 296, in the case of which the root ball of the tree is placed onto a securing plate, which is to be arranged in the ground soil in horizontal position, so as to subsequently secure the tree with the help of a guying.

Further tree securing devices, which provide for a securing plate underneath the root ball, are disclosed in the following documents: JP H08-103180 A, JP 2006-280316 A, KR 2010-0016897 A and JP H04-36127 A.

It has furthermore been proposed to provide frame-like wire designs underneath the root ball in the ground soil: GB 2 322 782 A, GB 2507066 A, JP 2009-219432, JP 2007-209293 and JP11-239422.

Document JP 2004-089037 A proposes a tree securing device, in the case of which a plate, which is embodied as grate and through which the tree trunk reaches and in the case of which corners are additionally guyed in the ground soil, is arranged above the root ball.

### SUMMARY

It is the task of the invention to specify improved technologies for securing trees, by means of which trees can be secured in their upright position in a simple and efficient manner, in particular newly planted young trees.

As a solution, provision is made for an arrangement comprising tree securing according to independent claim 1 as well as a tree securing plate according to independent claim 12. Advantageous further developments are the subject matter of dependent subclaims.

According to one aspect, an arrangement comprising tree securing is proposed. The arrangement encompasses a tree comprising a root ball, which is covered in a covering material, and a trunk comprising a tree crown on the end side. In particular, this can be a young tree. The covering material encompassing the roots can be embodied in one or in multiple layers. The root ball can thus be covered with a fabric material, which can be biodegradable. In addition, the covering material can encompass an exterior netting, for example a wire netting, through the openings of which the root system can develop in response to growth. The arrangement then has a tree securing device, which is accommodated in the ground soil and which is equipped to secure an upright position of the planted tree. The tree securing device is formed with a securing plate, which is arranged in the ground soil in horizontal position and so as to thus secure the tree against tilting out of the upright position.

The root ball stands on the cover surface of the securing plate and is supported thereon so as to be secured against lateral slipping such that a lateral shifting of the root ball relative to the cover surface is hindered or is ruled out completely. The securing plate can encompass an anti-slip plate section and a plate section, in particular on the exterior, which does not contribute to the anti-slip securing, but is covered by the ground soil and serves to secure the position of the securing plate in the ground soil in this respect. In one embodiment, the anti-slip plate section can be arranged in the middle area of the securing plate and can be surrounded circumferentially by the plate section, which does not contribute to the anti-slip securing. The plate section, which does not contribute to the anti-slip securing, can extend laterally beyond the root ball into the ground soil.

Bonding agents, by means of which a secure bond between root ball and securing plate is established, are formed on the root ball on the one side and on the securing plate on the cover surface side on the other side. The bond can be embodied so as to be releasable or non-releasable. The bonding agents formed on the root ball and on the securing plate interact, when the root ball is placed onto the securing plate when the tree is planted, whereby the secure bond is embodied. The bonding agents can be arranged on the covering material on the root ball, preferably on the exterior. The bonding agents can extend in a flat manner on the root ball and/or on the securing plate.

The bonding agents encompass Velcro® sections. The bonding agents can encompass strip and/or mat Velcro® sections. One or a plurality of Velcro® sections can be adhered or sewn to the covering material on the root ball. The fastening of Velcro® sections to the securing plate can take place by means of gluing.

According to a further aspect, provision is made for a tree securing plate for the above-described arrangement, wherein anti-slip elements and/or bonding agents are arranged on the cover surface side.

The securing plate can encompass a round or angled base area, for example a quadrangular base area.

The securing plate can be embedded completely in the ground soil. In the case of this embodiment, the securing plate is at least partially embedded in the ground soil on all sides. Provision can be made for only an area of the securing plate, which is covered by the root ball resting thereon, to be excluded from direct contact with the surrounding ground soil.

In the case of one embodiment, provision can be made for the securing plate to encompass one or a plurality of plate sections, which are embodied so as to allow water to drain through. It is made possible through this that water, which reaches onto the cover surface of the securing plate, is discharged downwards through it. The securing plate can encompass one or a plurality of plate sections, which are formed so as to form a reservoir for the water arriving on the cover side. In this reservoir area, the water, which reaches onto the securing plate on the cover side, cannot pass through said securing plate and is retained on the cover side in this regard. The securing plate can allow water to drain through across its entire surface. In the alternative, the securing plate can be embodied so as to retain water across the entire surface. It can be made possible for water to drain through in that the securing plate encompasses one or a plurality of openings, which can be focused in a partial section of the securing plate on the edge side and/or in the middle. In one embodiment, the plate sections, which allow water to drain through, can consist of a porous material, in which pores are formed, which provide for the water to pass from the cover side through the securing plate. Such an embodiment can be formed by means of a gravel plate, in the case of which a sand or gravel material is cast with an bonding agent or adhesive, for example a multi-component adhesive. After the bonding agent or adhesive, which can contain resin components, has hardened, a porous plate structure is created, through which water can reach from the cover side.

At least the covering material of the root ball can mesh with anti-slip elements on the cover surface side on the securing plate. The interaction of covering material and anti-slip elements on the cover surface side, which can be arranged in the anti-slip plate section, secures the root ball against a lateral slipping on the securing plate.

One embodiment can provide for the anti-slip elements on the cover surface side to encompass at least one of the following structure elements: projection, pin, journal, hook and flat surface roughening. The structure elements can be arranged individually or as group on the cover surface of the securing plate. The structure elements can hereby be formed on the securing plate in a fixed and non-releasable manner Preferably, the structure elements seize only the covering material, without engaging with the root ball per se.

On the cover surface side, the securing plate can be formed with a circumferential edge elevation. The circumferential edge elevation can be formed so as to be continuous or interrupted. A reservoir for water, which reaches from the ground soil onto the securing plate, can be formed on the cover side of the securing plate with the help of the edge elevation.

Preferably, a further development provides for the securing plate to additionally be anchored in the ground soil. The securing plate can be anchored additionally in the ground soil in this manner, for example with the help of pins or journals, which are inserted into the ground soil through openings in the securing plate. Provision can also be made for a guying, in the case of which ropes engage with the plate. In the alternative or in addition, projections, which extend into the ground soil when the securing plate is placed onto the ground soil, can be formed on the bottom surface of the securing plate. Such projections on the bottom side can be provided in corner areas and/or other exterior edge areas of the securing plate, for example.

The securing plate can consist of a biodegradable material, at least in sections. Biodegradable materials as such are known in various embodiments, for example also in the form of biodegradable plastics. Recycling materials can also be used. In the alternative, the securing plate can consist of metal, plastic or wood or of a combination thereof.

A further development can provide for the securing plate to project beyond the root ball on all sides, viewed from the top.

A further securing plate can be arranged above the root ball in the ground soil such that the trunk is guided through a plate opening. The securing plate above the root ball can be provided in addition to the securing plate underneath the root ball. To provide for an inflow of water and nutrients for the root ball, the securing plate is preferably made of a porous material or encompasses drainage openings when arranged above the root ball. In one embodiment, the securing plate consists of a gravel material, which is cast with an adhesive or bonding agent.

In the case of one embodiment, provision can be made for the securing plate to be embedded in the ground soil so as to be exposed on the cover side.

In the case of one embodiment, the securing plate can be formed with a circumferential frame, which, in top view, can encompass an angled or a round surface, for example. The surface, which is covered by the frame, is filled with a tensioning material, which is stretched by means of the frame. For example, a net or gauze material can be used, in particular of a synthetic material. However, a biodegradable material can be used. Bonding agents and/or adhesives can be applied to the cover surface, for example Velcro® sections.

### DESCRIPTION OF EXEMPLARY EMBODIMENTS

Exemplary embodiments will be explained below with reference to figures of a drawing.

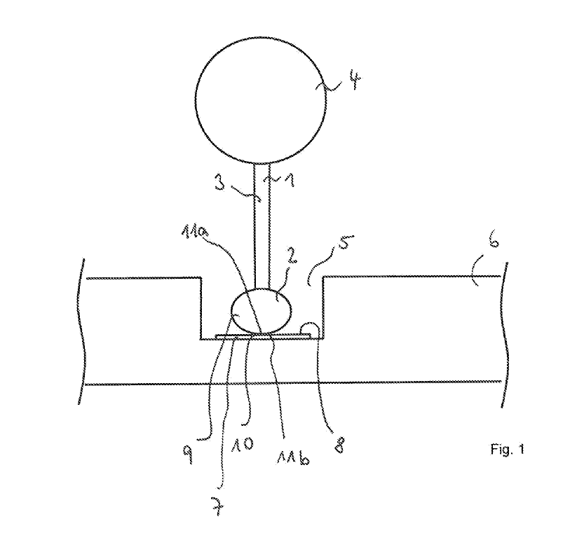

FIG. 1 shows a schematic illustration of an arrangement comprising a tree and a tree securing device, which is formed with a securing plate, which is arranged underneath a root ball,

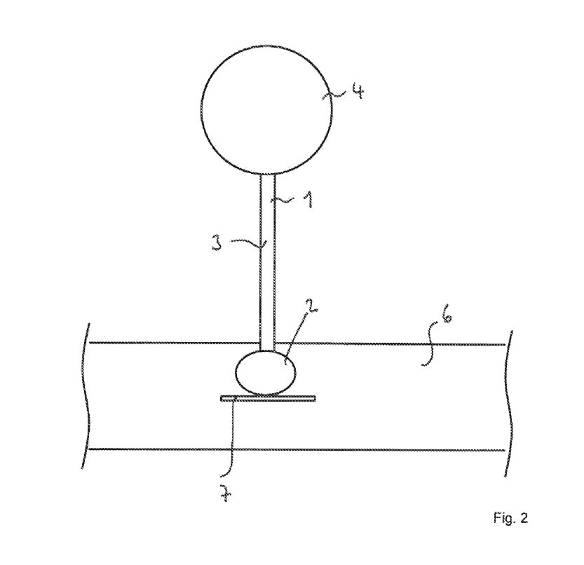

FIG. 2 shows a schematic illustration of the arrangement from FIG. 1, wherein a previously dug hole in the ground soil has been filled,

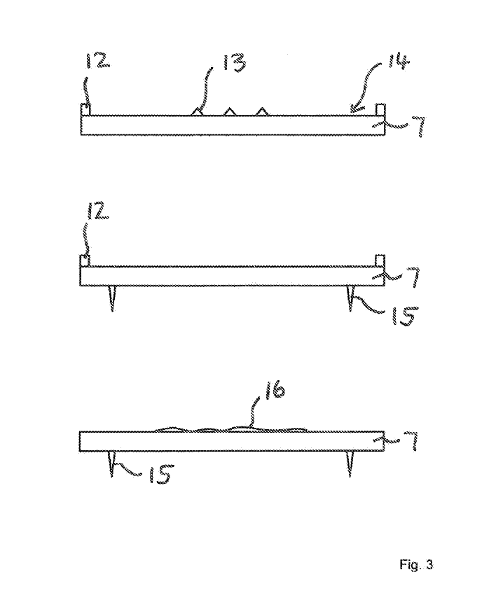

FIG. 3 shows a schematic illustration of embodiments of a securing plate in cross section and

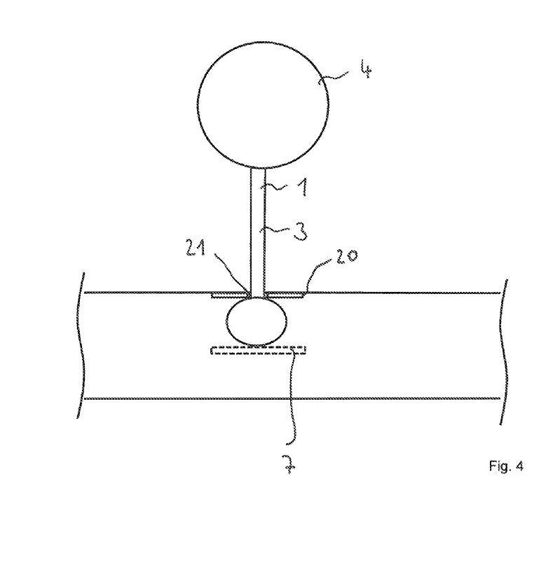

FIG. 4 shows an arrangement comprising a tree and a tree securing device, in the case of which a securing plate is arranged above the root ball.

FIG. 1 shows a schematic illustration of an arrangement comprising tree securing comprising a tree 1, which encompasses a root ball 2 and a trunk 3 comprising a tree crown 4 on the end side. For planting the tree 1, a securing plate 7, on the cover surface 8 of which the root ball 2 stands, is arranged in a hole 5 in the ground soil 6. The root ball 2 is surrounded by a covering material 9.

The root ball 2 is secured on the securing plate 7 against lateral slipping, in that an adhesive bond 10 is embodied between the root ball 2, in particular the covering material 9 thereof, and the securing plate 7. In the case of the shown embodiment, the adhesive bond 10 is established with the help of Velcro® sections 11a, 11b, which are arranged on the cover surface 8 of the securing plate 7 on the one side and on the covering material 9 of the root ball 2 on the other side. Strips or a mat can be formed on the root ball 2 and/or the securing plate 7 by means of the Velcro® sections 11a, 11b.

FIG. 2 shows the arrangement from FIG. 1, wherein the hole 5 is now filled with soil.

In the alternative or in addition, the adhesive bond 10 can be formed on the cover side of the securing plate 7 with the help of structure elements on the cover side. In the upper picture, FIG. 3 shows a schematic illustration of a securing plate 7 in cross section, in the case of which provision is made for a circumferential edge elevation 12 and structure elements 13 on the cover surface side, wherein said structure elements engage with the covering material 9, when the root ball 2 stands on the securing plate 7. A reservoir 14 for the water, which reaches through the ground soil 6 to the cover surface 8 of the securing plate 7, is formed on the securing plate 7 by means of the circumferential edge elevation 12.

FIG. 3 shows further embodiments of the securing plate 7 in cross section comprising pins 15 on the bottom side for additionally anchoring the securing plate 7 in the ground soil. For anti-slip protection, provision is made in one embodiment (bottom picture in FIG. 3) for a roughening or structuring 16 on the cover side, onto which the root ball 2 is placed when being planted.

FIG. 4 shows an arrangement, in the case of which an upper securing plate 20 is arranged above the root ball 2. The trunk 3 of the tree 1 reaches through an assigned opening 21 in the upper securing plate 20. The upper securing plate 20 consists of a porous material such that water, which reaches onto the upper securing plate 20, can reach through the latter into the ground soil 6 to the root ball 2. For this purpose, the upper securing plate 20 consists of a gravel material, which is cast with a liquid bonding agent or adhesive.

The features disclosed in the above description, the claims as well as the drawing can be significant for the realization of the various embodiments, alone as well as in any combination.

1. An arrangement for tree securing, comprising
a tree, which encompasses a root ball, which is covered in a covering material, and a trunk comprising a tree crown on the end side, and
a tree securing device, which is accommodated in the ground soil and which is equipped to secure an upright position of the planted tree,
wherein the tree securing device is formed with a securing plate, which is arranged in the ground soil in horizontal position and so as to thus secure the tree against tilting out of the upright position, and wherein the root ball stands on the cover surface of the securing plate and is supported thereon so as to be secured against lateral slipping such that a lateral shifting of the root ball relative to the cover surface is hindered or is ruled out completely, characterized in that bonding agents, by means of which secure bond between root ball and securing plate is established and which encompass hook-and-loop fasteners, are formed on the root ball on the one side and on the securing plate on the cover surface side on the other side.

2. The arrangement according to claim 1, wherein the securing plate is embedded completely in the ground soil.

3. The arrangement according to claim 1, the securing plate encompasses one or a plurality of plate sections, which are embodied so as to allow water to drain through.

4. The arrangement according to claim 1 wherein at least the covering material of the root ball can mesh with anti-slip elements on the cover surface side on the securing plate.

5. The arrangement according to claim 4, wherein the anti-slip elements on the cover surface side encompass at least one of the following structure elements: projection, pin, journal, hook and flat surface roughening.

6. The arrangement according to claim 1 wherein the securing plate is formed with a circumferential edge elevation on the cover surface side.

7. The arrangement according to claim 1 wherein the securing plate is additionally anchored in the ground soil.

8. The arrangement according to claim 1 wherein the securing plate consists of a biodegradable material, at least in sections.

9. The arrangement according to claim 1 wherein the securing plate projects beyond the root ball on all sides, viewed from the top.

10. The arrangement according to claim 1 further comprises a further securing plate is arranged above the root ball in the ground soil such that the trunk is guided through a plate opening.

11. The arrangement according to claim 10, wherein the further securing plate is embedded in the ground soil so as to be exposed on the cover side.

12. A tree securing plate (7) for an arrangement according to claim 1 wherein anti-slip elements and/or bonding agents, which encompass hook-and-loop fasteners, are arranged on the cover surface side.
